(19) United States
(12) Patent Application Publication
(10) Pub. No.: US 2024/0187314 A1
(43) Pub. Date: Jun. 6, 2024

(54) SYSTEM AND METHOD FOR FILTERING AND VISUAL PRESENTATION OF REAL-TIME NETWORK ANALYSIS OF DEVICE COMPLIANCE

(71) Applicant: RAKUTEN MOBILE, INC., Tokyo (JP)

(72) Inventors: Abhishek SINGH, San Mateo, CA (US); Karan ARORA, Indore (IN); Kunal KHANWILKAR, San Mateo, CA (US); Alok PAWAR, Indore (IN); Preetam SOLANKI, Indore (IN)

(73) Assignee: RAKUTEN MOBILE, INC., Tokyo (JP)

(21) Appl. No.: 17/799,869

(22) PCT Filed: Jun. 16, 2022
(86) PCT No.: PCT/US2022/033719

§ 371 Date: Aug. 15, 2022

(51) Int. Cl. H04L 41/22; G06T 11/20; H04L 43/08; H04L 67/75

(52) U.S. Cl. CPC H04L 41/22; G06T 11/206; H04L 43/08; H04L 67/75

(57) ABSTRACT

A system and method are provided for visual presentation of device compliance data from a network enabling intuitive identification of requirement non-compliance and targeted response thereto. Device data gathered from a plurality of devices communicably connected to a network is received and analyzed in a data analytics system to identify devices failing to comply with each network requirement of a predetermined set of network requirements. Results of the compliance analysis are selectively filtered according to at least one selected device feature of a plurality of predetermined device features, and a graphic user interface application generates graphical charts indicating an extent of non-compliance, among the filtered subset of the plurality of devices, for presentation on a display. A preset automated response based at least in part on identification of devices performing non-compliant activity within the network may then be executed to thereby reduce the non-compliant activity of the identified devices.

### TECHNICAL FIELD

Apparatuses, systems and methods in accordance with one or more embodiments are generally directed to the real-time analysis of the compliance of devices in a network with the requirements of the network, and the filtered presentation of the results of this analysis in a visually intuitive manner. The system generally provides for monitoring of “golden parameter” compliance, including automatic or visual identification of patterns in non-compliance which affect network performance, such that automatic or manual responses may more easily isolate problems.

### BACKGROUND

Modern networked systems, such as mobile phone networks, Internet connections, and cloud computing systems, must manage interactions between a wide variety of third-party devices connecting to the system.

To ensure that the network operates within acceptable parameters, the provider of the network will frequently encourage or require that each connected device comply with certain standards. These recommendations and requirements include the “golden parameters” that are considered performance-critical, as well as other standards which are less vital but still preferred.

However, it is difficult to pre-emptively prevent non-compliant devices from connecting to the system. Additionally, as a business decision, it may be better to adapt to the presence of non-compliant devices rather than restrict users whose technology is less up-to-date than desired, but this decision cannot be made wisely without having enough information to balance the extent of non-compliance against its harm.

Monitoring and performance analysis, to identify non-compliant devices, the portion that they form of the total devices in the system, and the effects they are having on performance, is therefore a regular and necessary aspect of network management.

### SUMMARY

It is an object of the disclosed system and method to provide analysis results of network requirement compliance in a comprehensible and organized manner.

It is another object of the disclosed system and method to enable easier identification of correlations between non-compliant devices and various factors.

It is yet another object of the disclosed system and method to enable targeted automatic and manual responses to non-compliance which affects the performance of a network.

It is still another object of the disclosed system and method to analyze network requirement compliance without reliance on daily “dumps” which may not be conveniently timed.

These and other objects may be attained in a system and method for filtering and visual presentation of real-time analysis of device compliance in a network. In accordance with certain embodiments of the present invention, a method is provided for visual presentation of device compliance data enabling intuitive identification of network requirement non-compliance and targeted response thereto. The method includes receiving device data gathered from a plurality of devices communicably connected to a network. The device data represents values of features and resulting activity of the devices. The method further includes, in a data analytics system executing on a processor, analyzing the device data to identify devices failing to comply with each network requirement of a predetermined set of network requirements, to thereby generate compliance analysis results. The method further includes selectively filtering the compliance analysis results according to at least one selected device feature of a plurality of predetermined device features, to thereby generate filtered analysis results representing a filtered subset of the plurality of devices. The method further includes, in a graphic user interface application executing on a processor, generating at least one graphical chart indicating an extent of non-compliance, among the filtered subset of the plurality of devices, with a selected subset of the network requirements, according at least in part to the filtered analysis results. The method further includes presenting the graphical chart in a graphic user interface rendered on a display.

In accordance with other embodiments of the present invention, a system is provided for visual presentation of device compliance data enabling intuitive identification of network requirement non-compliance and targeted response thereto. The system includes a data analytics system executing on a processor and configured to analyze device data to identify devices failing to comply with each network requirement of a predetermined set of network requirements, to thereby generate compliance analysis results. The device data is gathered from a plurality of devices communicably connected to a network, and represents values of features and resulting activity of the devices. The system further includes a database implemented in a computer memory and configured to store the compliance analysis results. The system further includes a graphic user interface application executing on a processor. The graphic user interface application is configured to selectively filter the compliance analysis results according to at least one selected device feature of a plurality of predetermined device features, to thereby generate filtered analysis results representing a filtered subset of the plurality of devices. The graphic user interface application is further configured to generate at least one graphical chart indicating an extent of non-compliance, among the filtered subset of the plurality of devices, with a selected subset of the network requirements, according at least in part to the filtered analysis results. The graphic user interface application is further configured to render a graphic user interface on a display. The graphical chart is presented in the graphic user interface.

In accordance with still other embodiments of the present invention, a non-transitory computer-readable recording medium is provided. Recorded on the medium are instructions executable by at least one processor to perform a method of visual presentation of device compliance data from a network enabling intuitive identification of requirement non-compliance and targeted response thereto. The method includes receiving device data gathered from a plurality of devices communicably connected to the network. The device data represents values of features and resulting activity of the devices. The method further includes, in a data analytics system executing on a processor, analyzing the device data to identify devices failing to comply with each network requirement of a predetermined set of network requirements, to thereby generate compliance analysis results. The method further includes selectively filtering the compliance analysis results according to at least one selected device feature of a plurality of predetermined device features, to thereby generate filtered analysis results representing a filtered subset of the plurality of devices. The method further includes, in a graphic user interface application executing on a processor, generating at least one graphical chart indicating an extent of non-compliance, among the filtered subset of the plurality of devices, with a selected subset of the network requirements, according at least in part to the filtered analysis results. The method further includes presenting the graphical chart in a graphic user interface rendered on a display.

Additional aspects, details, and advantages of the disclosed system and method will be set forth, in part, in the description and figures which follow.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a block diagram illustrating a system for analyzing and presenting device compliance data in a network, in accordance with an exemplary embodiment of the present invention;

FIG. 2 is a depiction of an illustrative example of a graphic user interface for filtering device compliance analysis results, in accordance with an exemplary embodiment of the present invention;

FIGS. 3A-1 through 3H-2 are depictions of an illustrative example of a graphic user interface for displaying filtered device compliance analysis results, in accordance with an exemplary embodiment of the present invention;

FIGS. 4A and 4B are flow diagrams illustrating flows of processes for analyzing and presenting device compliance data in a network, in accordance with an exemplary embodiment of the present invention; and

FIG. 5 is a diagram of components of one or more devices, in accordance with an exemplary embodiment of the present invention.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

It is noted that the principles disclosed herein are generally applicable to all forms of networks, including but not limited to internet service provider networks such as optical fiber and cable networks; traditional phone networks; and both wired and wireless networks in a structure, complex, or other localized area. However, throughout the disclosure, the network being analyzed and managed by the disclosed system will be primarily referred to as a mobile network for convenience and clarity purposes.

As discussed briefly in the background of this disclosure, performance of a network and the devices connected thereto is improved when all devices (or, failing that, as many devices as possible) meet or exceed certain requirements. The types and minimum values of these requirements, sometimes referred to as “golden parameters” in the art, will vary from network to network. In the context of mobile networks, a few non-limiting examples are network source, DRX cycle type, admin site, and entry threshold (for a Radio Access Network). If the values for these parameters deviate from a preset “golden value,” or a range or set of such values, then performance of the device can be affected negatively due to unexpected operation.

In the related art, network performance monitoring is handled on a periodic basis, such as in the form of a daily compilation of data or so-called “daily dump,” which is processed, analyzed, and converted into a report. This is not helpful for diagnosing or managing serious issues that arise mid-day. Such problems are particularly likely to occur following a configuration change or corrective implementation, where it would be ideal to have a prompt evaluation of how the altered system is now operating. More generally, the network and its managers, both human and automated, are less responsive as a result of this limitation.

Additionally, especially in the internet service or mobile service fields, the number of networked devices can be overwhelmingly large for manual review, on the order of millions of individual devices. Systems in the related art prepare and display reports regarding these devices in a manner that is not convenient for evaluation of non-compliance, especially in or between specific groupings. It is impossible to identify patterns in this data which could help to resolve non-compliance issues or related performance degradation.

Example embodiments of the present disclosure provide a system for real-time auditing of performance, including identification of non-compliant devices, based on analysis of a real-time data stream. The generated analysis results can also be filtered and/or broken down for comparison according to a variety of factors which describe the devices and their activity, such as geographic regions, domains, vendors, and connection technologies, among others. Furthermore, the data is presented through a graphical user interface (GUI) that provides options for several display “widgets,” each presenting the data in one or more visually-intuitive charts.

By providing for real-time analysis of the network, developing problems, related to non-compliance or otherwise, can be quickly identified and then responded to in a targeted manner. A configuration change can be rapidly reviewed for resulting performance degradation.

In certain emergency cases, preset automated responses can engage to restrict the access of, or even entirely disconnect, problematic devices or groupings of devices which are creating a drag on the system due to their non-compliant activity. As but one of many examples, if it is determined that devices manufactured by a particular vendor are not compliant when connected over 5G, those devices can be automatically shifted to LTE connections until the matter is resolved. As another example, if it is determined that a network configuration change conducted earlier that day has caused all ODSC-based connections to degrade performance of the entire network, such connections can be automatically disconnected or throttled until the change is reverted or patched. Still other automated responses can be imagined by those of skill in the art.

Similarly, an adjustment to the golden parameters can be pre-tested on the fly, to determine how many devices will no longer be compliant in a new network configuration. It can then be decided the same day whether the network changes which necessitate the parameter adjustment are either desirable or feasible.

The visual display features disclosed herein further assist in this aspect by presenting non-compliance data in a more comprehensible manner, particularly with respect to particular regions, vendors, technologies, or other aspects which can be identified as particularly problematic and addressed in a targeted manner. Using this information, technicians can determine whether to manually implement and/or execute responses much like the automated responses described above, and additionally can determine whether such responses, automated or otherwise, are in response to a resolved issue or a “false positive” and therefore can be revoked. More generally, the technicians can more easily and intuitively identify changes in non-compliance and other trends with the assistance of the disclosed filters and visualizations, without being overwhelmed by pages full of data.

It is noted that, although the real-time analysis features and the filtering and visual display features are preferably implemented in cooperation with each other, either can be implemented without the other yet still resolve challenges in the management of a communication network. As such, embodiments with real-time analysis but not filtering or visual presentation, and vice versa, are both within the scope of the invention.

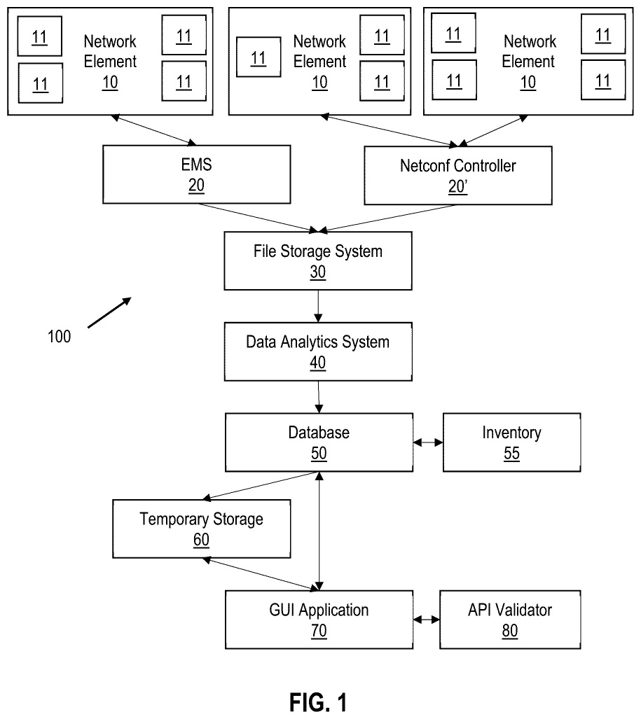

An illustrative diagram of a system architecture of a system 100 for analyzing and presenting device compliance data in a network will now be described with reference to FIG. 1, according to an embodiment of the invention.

The network itself includes a plurality of network elements 10 which are communicably connected with an element management system 20.

Each network element 10 includes one or more physical devices 11 which, for convenience, are grouped together as a single unit for management purposes. For example, the individual devices 11 in a network element 10 may connect to the network through a single connection point. The physical devices 11 themselves are devices such as mobile phones or tablets which are communicatively connected to the network, directly or through an intermediary.

The element management system (EMS) 20 manages the configuration and security of the connections to the network elements 10. Importantly for the purposes of the present system, the EMS 20 also monitors the devices for quality and performance, and collects related data.

It is noted that, in the specific context of a 5G mobile network and its connections, a netconf controller 20′ implements the functions normally managed by an EMS 20. Generally, present mobile networks can be expected to employ a plurality of both netconf controllers 20′ and traditional EMSs 20, to manage the connections of both 5G-connected devices and devices without 5G capabilities. For the purposes of the present disclosure, both netconf controllers 20′ and traditional EMSs 20, as well as other systems known in the art to be suitable for such management of network elements 10, will be treated interchangeably herein.

The illustrated embodiment of the present system further includes a file storage system 30, a data analytics system 40, a database 50 with associated inventory 55, an optional temporary data storage 60, a graphical user interface (GUI) application 70, and an optional API validator 80.

The file storage system 30 stores the data collected by the EMS 20, for later retrieval. The file storage system 30 is preferably cloud-based, and can be implemented using MinIO, Hbase, or other suitable digital storage systems known in the art. The EMS 20 preferably provides the data to the file storage system 30 in the form of a real-time data stream. However, embodiments transmitting the data as a series of periodic compilations—for example, daily compilations—are also within the scope of the invention.

The data analytics system 40, also known as a data flow control system or process runner in the art, collects and organizes the data from the file storage system 30 for entry into the database 50. The data analytics system 40 can be implemented using Apache Nifi and Apache Spark, or other suitable data analysis systems known in the art. The database 50 can be implemented using MySQL or YugabyteDB, or other suitable databases known in the art. Both the data analytics system 40 and the database 50 are preferably implemented on a server or cluster of servers connected to the network, the data analytics system 40 executing on a processor of at least one of the servers and the database 50 implemented in a memory of at least one of the servers. In embodiments where the EMS 20 provides a real-time data stream, the data analytics system 40 preferably operates continuously or regularly on the most recent data in the file storage system 30 so as to provide real-time analysis and auditing.

Preferably, an inventory 55 is included. The inventory 55 is a module which manages mapping, NETTYPE configuration, and other similar parameters.

The data analytics system 40 analyzes and organizes the data such that it contains information about the specifications and activity of each device, and whether, as a result, each device fails to comply with the requirements of the network. In certain embodiments, the data analytics system 40 also activates any automated responses to identified issues in the network, related to non-compliance or otherwise, but in other embodiments these functions are managed by a suitable separate component (not depicted).

The GUI application 70 selectively displays representations of the data in the database 50 to a user, in accordance with the user's selected settings and filters. The GUI application 70 renders this data as part of a GUI on a display. Some example embodiments of this GUI will be detailed in depth further herein. Various suitable displays for rendering and displaying the GUI and the data are known in the art and include any device capable of visual presentation, including but not limited to a computer monitor, laptop screen, tablet screen, handheld screen, panel screen, smart phone, smart watch, television, projector, electronic paper, head-mounted display, holographic display or other three-dimensional projector, or virtual reality/augmented reality system. The GUI application 70 itself can be implemented on any suitable computer system which includes or is communicably connected to the display, and preferably executes on a processor of this computer system.

In embodiments where the EMS 20 provides a real-time data stream and the data analytics system 40 continuously analyzes the data stream contents and populates the database with the most up-to-date analysis results, the GUI application will be able to display real-time data for each call to the database 50.

The GUI application 70 is implemented through an application programming interface (API), which is preferably a REST API—that is, it conforms to the REpresentational State Transfer architectural style—although other API styles and designs are also suitable and within the scope of the invention. Preferably, the GUI application 70 is a web application operating within a standard web browser, although self-contained applications are also within the scope of the invention. The backend framework for the application can be Spring Boot, or other suitable frameworks known in the art.

Optionally but preferably, a temporary data storage 60 keeps copies of data recently accessed by the GUI application 70 from the database 50. In many instances, after viewing data in the GUI application 70, a user will desire to view the same data in a different chart or different format, for the context of a different perspective. Or, the user will wish to view the details of a subset of the previously viewed data. In such instances, temporary data storage 60 will save time and bandwidth by having the data ready to display again. The temporary data storage 60 is quicker to retrieve data from than the database 50, as it is smaller and contains less data to search for the desired portion; in certain embodiments, it is also implemented on faster hardware, and/or has a more direct and faster connection to the subsystem executing the GUI application 70, than the database 50. Apache Livy is one service that supplies such functionality, but other suitable services are also known in the art.

Optionally but preferably, an API validator 80 confirms that the widgets and other aspects of the GUI application 70 are functioning according to the API specification. Swagger is one development toolset that supplies such functionality, but other suitable toolsets and services are also known in the art.

Once the contents of the analysis produced by the data analytics system 40 are stored to the database 50, they can be presented to a user through the GUI application 70 in a visual report, which is automatically generated by the GUI application 70 and rendered as part of the GUI. Preferably, the user is provided with functionality to filter the data prior and/or during viewing, according to various factors, and the GUI application 70 responsively adjusts the data presented in the visual report. The visual report preferably contains one or more graphical charts which present the analysis results to indicate levels and extent of non-compliance, among other important aspects of device behavior and characteristics, in a visually intuitive manner. Preferably, the GUI application 70 provides the user with functionality to selectively display one or more chart formats from a predetermined set of formats on a page of the GUI. Preferably, the user can interact with at least some of these charts to actuate the display of further data.

Illustrative examples of GUI pages for filtering and presenting device compliance analysis results will now be described with reference to FIGS. 2 and 3A-1 through 3H-2, according to an embodiment of the invention.

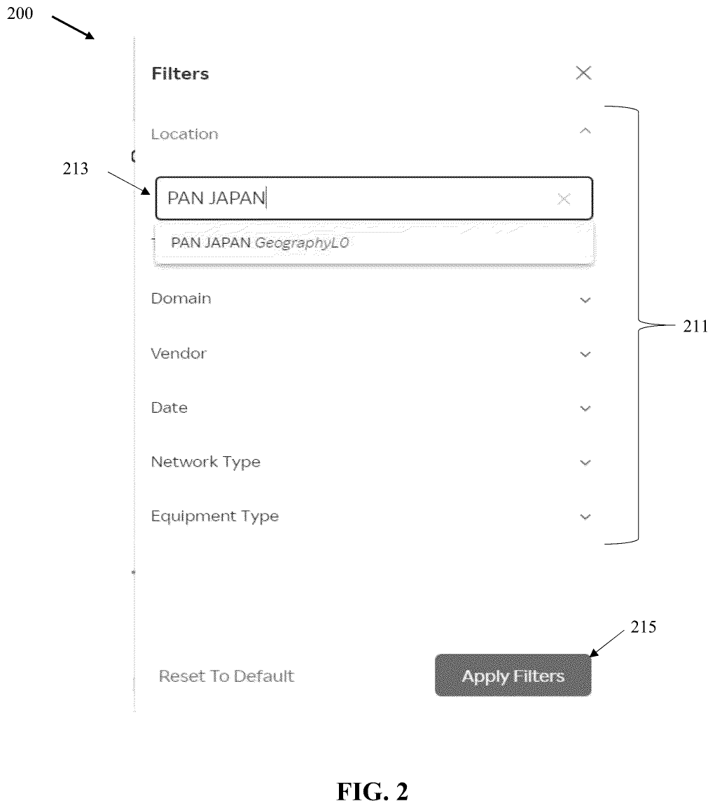

In a filtering GUI page 200, illustrated in FIG. 2, a user may filter the results to be displayed in the visual reports according to one of several factors, which are preferably various features of the devices—including but not limited to their physical specifications, their activity, and their point of connection to the network—as described in the results. The depicted factors are illustrative but by no means limiting, and systems implementing more, less, or different factors are within the scope of the invention.

Each of the factors 211 has a selector 213 which enables a user to select one or more values for the factor 211, which will direct the system to filter the analysis results according to the selected values. The depicted GUI page uses an “accordion” style of interface which allows a user to “open” access to one selector 213 for a corresponding factor 211 at a time for viewing and control. However, a page which has all selectors viewable and controllable simultaneously is within the scope of the invention, as is a series of pages each with a different factor selector. Other suitable arrangements of the selectors which can be imagined by those of skill in the art are also within the scope of the invention.

Likewise, the depicted form of each selector is not controlling. Numerous suitable selector forms for each factor are known in the art and within the scope of the invention. These forms include, where appropriate to the factor and possible selections therefor: dropdowns, list boxes, carousels, buttons, toggles, checkbox menus, radio button menus, dials, sliders, calendar date pickers, and text fields, among others, as well as combinations of any of the above.

In the illustrative example depicted in FIG. 2, the user is more specifically viewing the selector 213 for the “Location” filtering factor. As depicted, the selector 213 takes the form of a text field which, as the user types within the field, automatically provides search results below from a predetermined list of selectable regions. The user has typed “PAN JAPAN” into the location selector 213, for which there is only one search result, the PAN JAPAN geographic location (that is, everywhere within the nation of Japan). The user can then select PAN JAPAN from the search results, making this the selected value for the Location factor. The filtered results in later pages will provide data regarding devices located within the PAN JAPAN geographic location. Other selectors can be implemented and operated in a similar manner.

As can be seen, other factors which can be selected from for filtering include: “Technology” (that is, technology standards such as LTE and 5G); “Domain”; “Vendor” (that is, vendors of devices connected to the network); “Date” (that is, device data concerning devices connected to the network on that date, or alternatively data exclusive to that date); “Network Type” (that is, types of network access nodes); and “Equipment Type.” Again, this list is not limiting.

It is noted that the selection made in one selector can, in certain configurations, alter the options presented in other selectors. In one of many possible example scenarios, it might be known that a particular phone vendor only sells older devices without 5G capability. As such, the system can be configured such that, if that vendor is presently selected for Vendor, “5G” is not displayed as an available option for Technology. In another example scenario, it might be known that a particular geographic region does not have any of a particular type of network access node present. As such, the system can be configured such that, if that region is presently selected for Location, that type of node is not an available selection for Network Type.

Once the user has made selections in any desired selectors such as selector 213, which may be some, all, or none of the selectors 213, they may filter the analysis results by applying the filter selections through button 215.

The data itself is, as of this stage, stored in the database 50 or the temporary data storage 60. Each entry in the database 50 contains a complete description of a device 11 in the network, including all characteristics by which it may be filtered. Several suitable processes for filtering such a database are known in the art and need not be elaborated on here.

The filtered results are then presented in one or more charts or graphs, each of which is preferably a visually intuitive and interactive presentation of key aspects of the analysis. Preferably, each style of chart is designed to provide information about the extent of non-compliance within the filtered subset of the devices, such that a user can visually determine when a high non-compliance rate is present. In a preferred embodiment, the user is provided with a dashboard GUI which allows the placement and arrangement of one or more predesigned GUI “widgets,” each widget having a chart of a different chart style rendered within. The dashboard can have an arrangement of regions, such as a grid, into which the widgets, and by extension the charts being graphically rendered within, may be placed. The user can select from a set of possible widgets and can further choose a region in which to place the selected widget. In a preferred embodiment, the user can select not only which widgets go into which region, but the arrangement of regions itself, selected from a set of possible arrangements.

Some illustrative and non-limiting examples of widgets and their respective charts, implemented in a dashboard 300, are depicted in FIGS. 3A-1 through 3H-2. Preferably, each widget includes an “expand view” button 311 which opens an expansion of the presented information, in the form of a detailed list. Optionally, some or all of the values used for the applied filters—in the depicted examples, the domain value 313 and/or date value 315—are indicated in each widget as a reminder to the user.

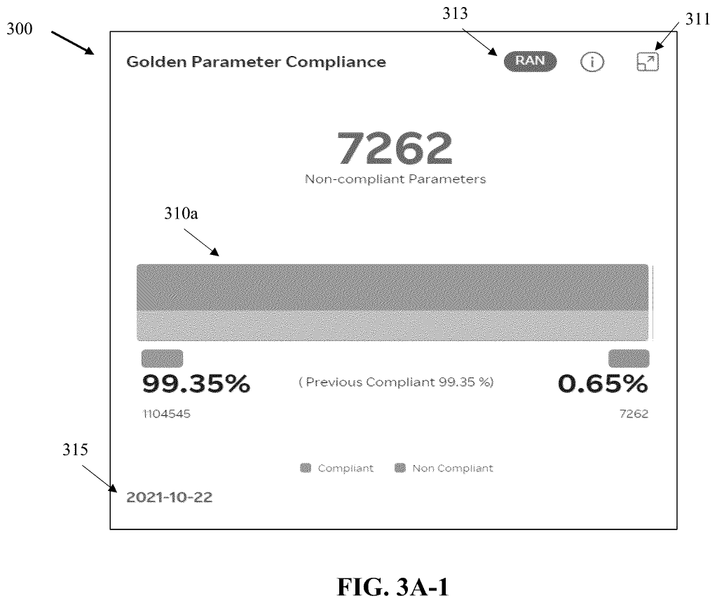

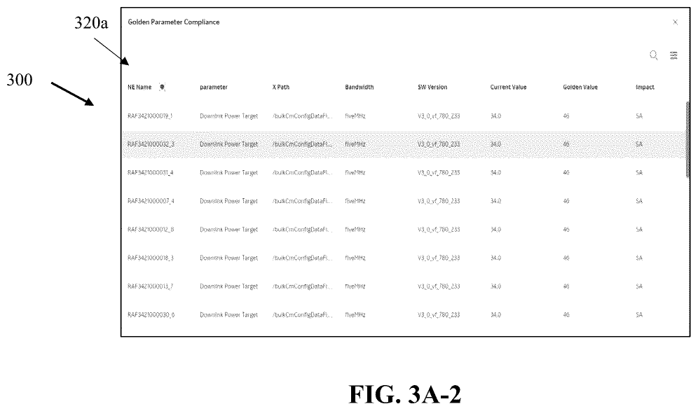

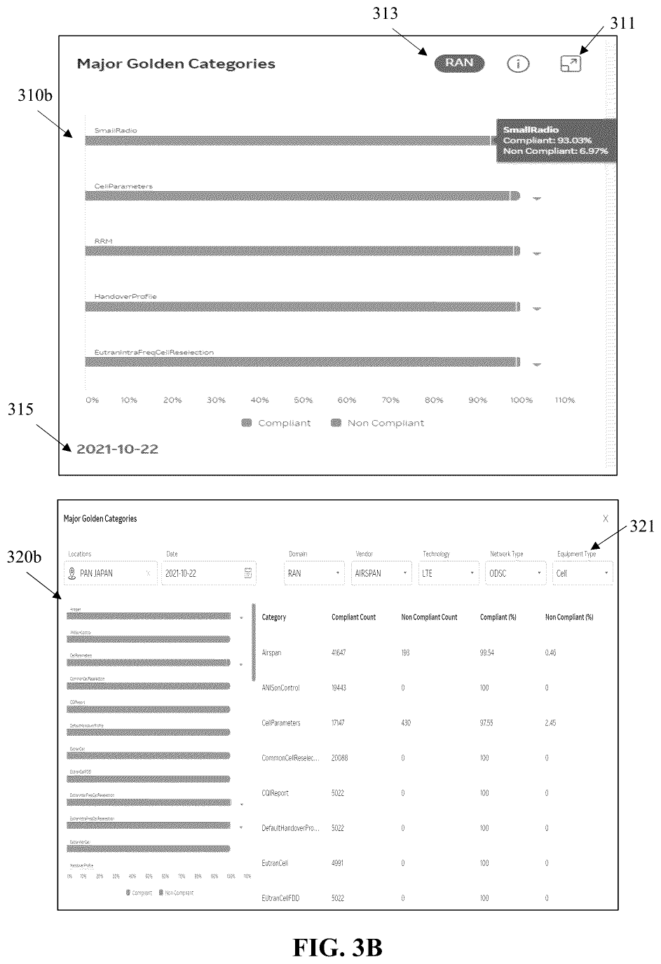

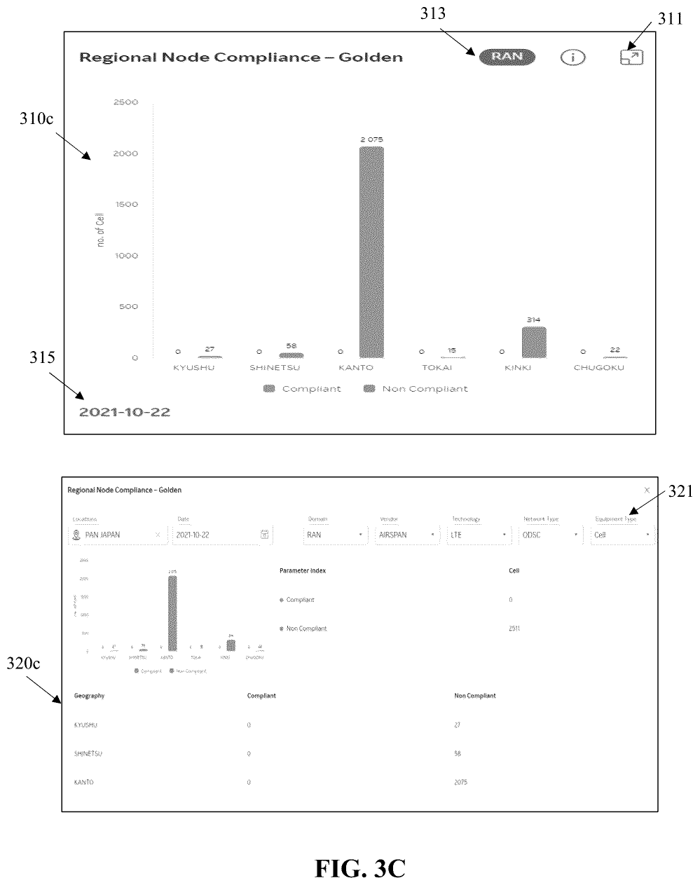

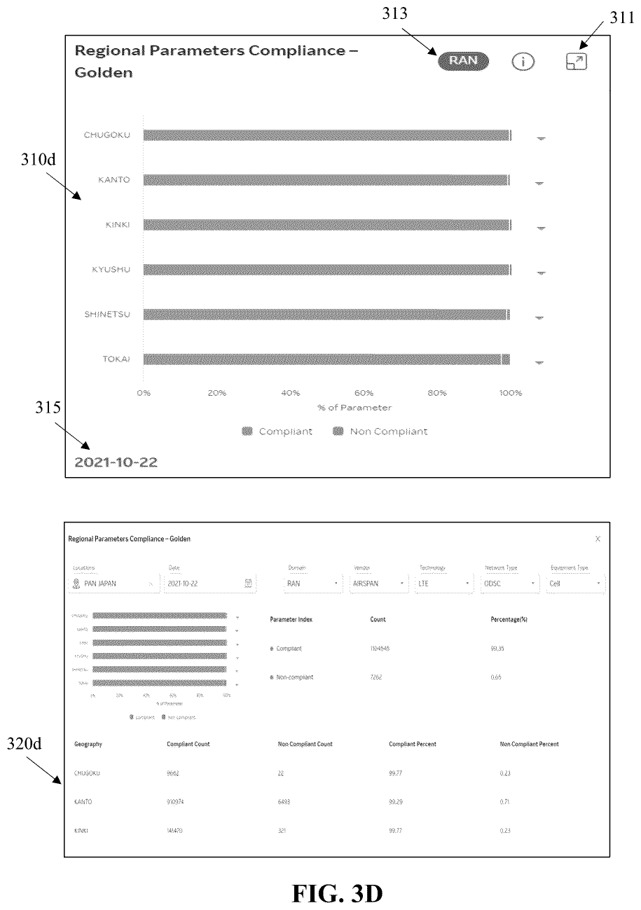

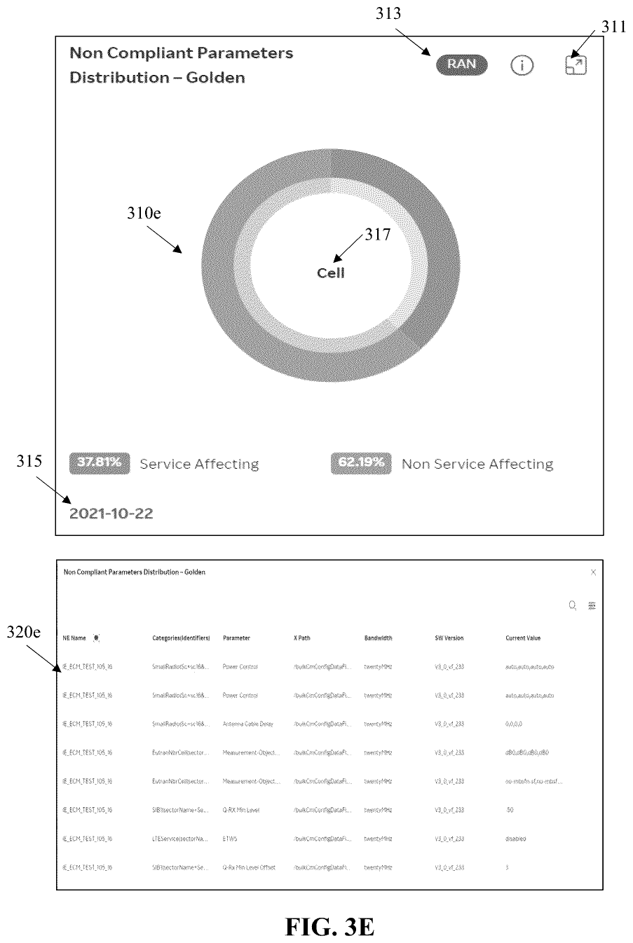

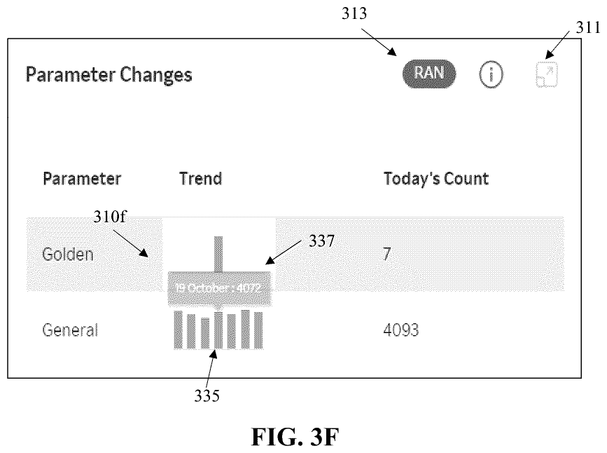

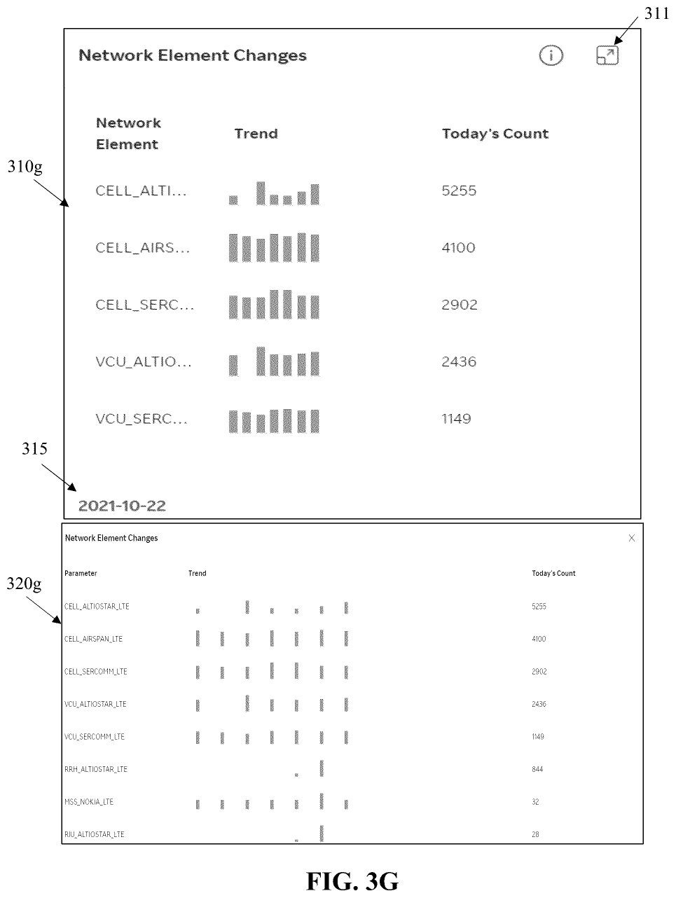

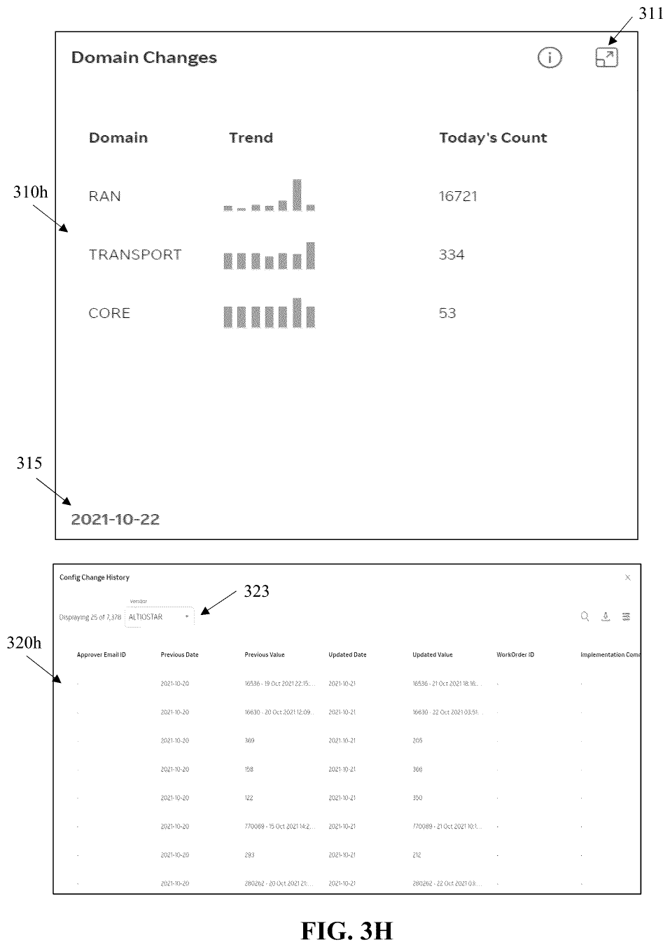

The chart 310a for the illustrative widget depicted in FIG. 3A-1 displays a divided bar graph showing percentages of compliant and non-compliant devices for the golden parameters generally. Here, any device failing to be compliant with at least one applicable golden parameter is categorized as “non-compliant.” The raw numbers of compliant and non-compliant devices are also presented, as is a “previous” percentage of compliant devices; the latter indicates to a viewer that the compliance percentage is trending down. Actuating the expand button 311 opens a list 320a of non-compliant devices and their features, for example as depicted in FIG. 3A-2.

The chart 310b for the illustrative widget depicted in FIG. 3B-1 displays a divided bar graph showing percentages of compliant and non-compliant devices for five of the golden parameters: specifically, the five parameters which show the highest percentage of non-compliant devices. Here, any device failing to be compliant with the specified golden parameter is categorized as “non-compliant” for that parameter. Actuating the arrow button 331 next any one of the ratio visualizations will open a textbox 333 containing a text expression of the percentage ratio. Actuating the expand button 311 opens a list 320b of all individual golden parameters and their compliance information, for example as depicted in FIG. 3B-2. Filter selectors 321 are presented across the top of the list 320b, such that a user is reminded of all applied filter values, and can optionally alter them as applied to the list 320b.

The chart 310c for the illustrative widget depicted in FIG. 3C-1 displays a traditional bar graph showing compliance information by region or sub-region. Chart 310c shows the raw numbers of non-compliant devices in each region or sub-region of the relevant geographic area, which has been filtered or not filtered according to a filter selection made earlier (for example, by use of the filter selector 213a described above with reference to FIG. 2A). FIG. 3C-1 more specifically depicts the case where the relevant geographic area is all of the nation of Japan, which the illustrative embodiment divides into regions of relevance. (It is noted that, as depicted here, areas having no network coverage, no devices within the network, or so few devices that they can be ignored for analysis purposes, are not displayed.) Actuating the expand button 311 opens a list 320c presenting the same numbers in a simple list, for example as depicted in FIG. 3C-2, and again presents filter selectors 321 across the top for manipulation. A reduced version of chart 310c is also presented alongside the list 320c.

The chart 310d for the illustrative widget depicted in FIG. 3D-1 displays the same data as the chart 310c, but using a divided bar graph in the style of chart 310b. Actuating the expand button 311 opens a list 320d much like list 320c, but with a reduced version of chart 310d, for example as depicted in FIG. 3D-2.

The chart 310e for the illustrative widget depicted in FIG. 3E-1 displays a pie chart breaking down the golden parameter non-compliant devices by percentage into those which do not affect service, and those which do affect service. It is noted that the depicted chart, along with the domain value 313 and date value 315 as shown in other illustrative widgets previously, also displays the selected equipment type value 317. Actuating the expand button 311 opens a list 320e of individual non-compliant devices which affect service, for example as depicted in FIG. 3E-2.

The chart 310f for the illustrative widget depicted in FIG. 3F displays a bar chart showing the number of golden parameter non-compliant devices over a seven day period, that period ending in the date selected for filtering purposes. That is to say, the chart 310f displays a seven day trend of non-compliance. Non-compliance with “general” parameters—that is, parameters that are not performance critical but still ideal—is also displayed in a similar presentation. Actuating any of the bars in the chart, such as bar 335, will open a textbox 337 containing a text expression of the relevant data and raw number of devices. As depicted in the figure, the expand button 311 is disabled in this widget and no expanded list is provided for this widget.

The chart 310g for the illustrative widget depicted in FIG. 3G-1 displays a series of bar charts showing the number of devices in a network element changing their parameter values for any golden parameter over a seven day period, that period ending in the date selected for filtering purposes. That is to say, the chart 310g displays a seven day trend of changes in each network element, whether resulting in a change from compliance to non-compliance, from non-compliance to compliance, or having no effect on a compliance/non-compliance status. To keep the chart 310g from overflowing the space, only the five network elements with the greatest number of changes are displayed in the chart 310g as illustrated. However, actuating the expand button 311 opens a list 320g with an expansion of the chart showing all network elements, for example as depicted in FIG. 3G-2.

The chart 310h for the illustrative widget depicted in FIG. 3H-1 displays a series of bar charts showing the number of devices in a domain changing their parameter values for any golden parameter over a seven day period, that period ending in the date selected for filtering purposes. That is to say, the chart 310h displays a seven day trend of network changes in each domain, whether resulting in a change from compliance to non-compliance, from non-compliance to compliance, or having no effect on a compliance/non-compliance status. Actuating the expand button 311 opens a list 320h of all configuration changes, for example as depicted in FIG. 3H-2. As depicted, the list 320h includes a vendor filter dropdown 323 to filter this list, but other embodiments include the entire set of filter selectors 321 as depicted in other figures, or some other subset thereof.

It is again noted that the above widgets and their charts are illustrative examples, and may be modified in numerous ways which, based on the above disclosures, will be clear to those of skill in the art.

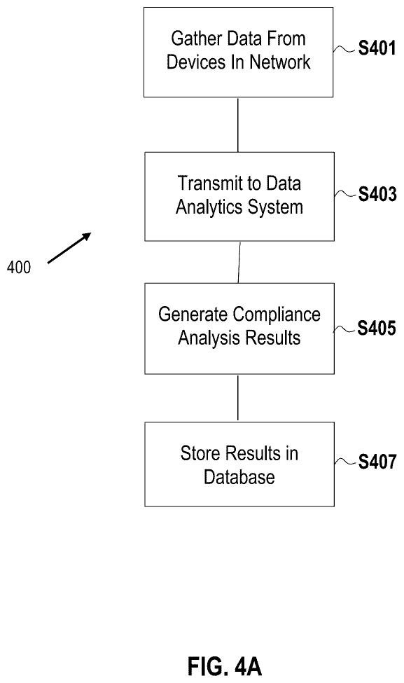

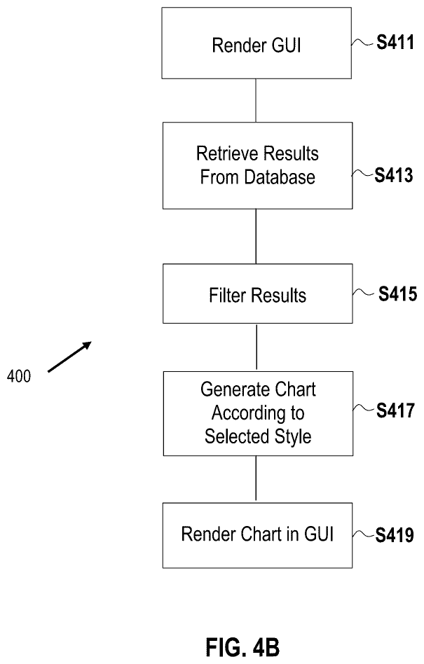

A flow of processes for analyzing and presenting device compliance data in a network will now be described with reference to FIGS. 4A and 4B, according to an embodiment of the invention.

In a method 400 for analyzing and presenting device compliance data, at S401, the EMSs 20 and/or netconf controllers 20′ in the network gather data from the devices connected thereto and store it in the file storage system 30. The data includes information on various device features and activity by the devices, such as the features and device behavior described previously.

At S403, the gathered device data is transmitted to and received by the data analytics system 40. As received, the data may be in the form of a periodic compilation of data, such as a daily compilation, but is preferably in the form of a real-time data stream.

At S405, the data analytics system 40 analyzes the device data. In particular, the data analytics system 40 maintains a set of network requirements for the network, and identifies when a device feature or the activity of a device does not comply with one of the network requirements. If so, the device is determined to be non-compliant with that network requirement. The data analytics system 40 generates compliance analysis results, which include this determination of non-compliance, preferably in association with the data which was used to make the determination.

At S407, the compliance analysis results are stored in the database 50.

In embodiments which implement a real-time data stream, this process is continuously operating, and in certain implementations all operations are occurring simultaneously or nearly simultaneously, with each operation using the most recent output of the previous operation in the process flow. In a simplified example, while data analytics system 40 is storing analysis results based on data originally gathered at time T, it is also analyzing data originally gathered at time T+t, and receiving data gathered at time T+2t, while the EMSs 20 and/or netconf controllers 20′ are gathering yet another set of data for time T+3t. It will be understood that the exact timing of each cycle will be in accordance with the speeds of the various operations.

Moving on to FIG. 4B, at S411, the graphic user interface (GUI) application 70 renders a GUI on a display.

At S413, preferably responsive to user input received through the GUI, the GUI application 70 is actuated to retrieve compliance analysis results from the database 50.

At S415, the GUI application 70 filters the retrieved results, preferably in accordance with selections made through the GUI, such as by the selectors described above with respect to FIGS. 2A-2G. The resulting filtered results thereby represent the subset of the devices which match to the filter selections.

In an alternative embodiment, the results are filtered simultaneous with retrieval from the database 50, and the GUI application 70 thereby retrieves only the analysis results which are in accordance with the filter selections. Which approach is preferable will be dependent on factors including but not limited to the access time for the memory storing the database 50, the processing power of the computer system executing the GUI application 70, and the bandwidth between the two.

At S417, the GUI application 70 generates at least one graphical chart for presentation, preferably in accordance with selections made through the GUI, such as by the user arrangement of “widgets” described previously. Each chart indicates aspects of the filtered analysis results, and can also indicate other information such as identification of the selected and applied filters. Each chart style is designed to visually express an extent of non-compliance with a respective subset of the network requirements; this subset may be all network requirements, the “golden parameters,” or a single requirement, among other options. Some example styles of charts which are effective at expressing this information have been described above with respect to FIGS. 3A-3H, although many other suitable styles are possible.

The charts are then rendered in the GUI, for example in their respective “widgets,” at S419.

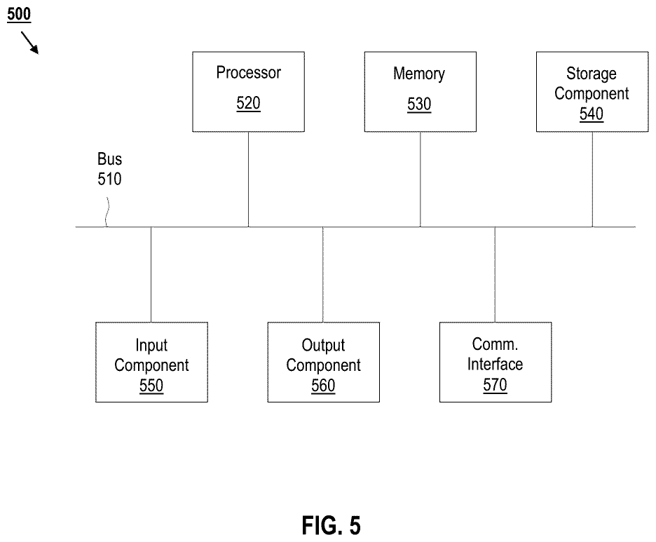

FIG. 5 is a diagram of components of one or more devices according to an embodiment. Device 500 may correspond to any computing device described above (such as physical devices 11, EMS 20, netconf controller 20′, and data analytics system 40), as well as to a processor executing any described software or method (such as GUI application 70 and API validator 80), and to a memory containing any described data storage (such as database 50 and temporary data storage 60).

As shown in FIG. 5, the device 500 may include a bus 510, a processor 520, a memory 530, a storage component 540, an input component 550, an output component 560, and a communication interface 570. It is understood that one or more of the components may be omitted and/or one or more additional components may be included.

The bus 510 includes a component that permits communication among the components of the device 500. The processor 520 is implemented in hardware, firmware, or a combination of hardware and software. The processor 520 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 520 includes one or more processors capable of being programmed to perform a function.

The memory 530 includes a random access memory (RAM), a read only memory (ROM), and/or another type of dynamic or static storage device (e.g., a flash memory, a magnetic memory, and/or an optical memory) that stores information and/or instructions for use by the processor 520.

The storage component 540 stores information and/or software related to the operation and use of the device 500. For example, the storage component 540 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 550 includes a component that permits the device 500 to receive information, such as via user input (e.g., a touch screen display, a keyboard, a keypad, a mouse, a button, a switch, and/or a microphone). The input component 550 may include a sensor for sensing information (e.g., a global positioning system (GPS) component, an accelerometer, a gyroscope, and/or an actuator).

The output component 560 includes a component that provides output information from the device 500 (e.g., a display, a speaker, and/or one or more light-emitting diodes (LEDs)).

The communication interface 570 includes a transceiver-like component (e.g., a transceiver and/or a separate receiver and transmitter) that enables the device 500 to communicate with other devices, such as via a wired connection, a wireless connection, or a combination of wired and wireless connections. The communication interface 570 may permit device 500 to receive information from another device and/or provide information to another device. For example, the communication interface 570 may include an Ethernet interface, an optical interface, a coaxial interface, an infrared interface, a radio frequency (RF) interface, a universal serial bus (USB) interface, a Wi-Fi interface, a cellular network interface, or the like.

The device 500 may perform one or more processes described herein. The device 500 may perform operations based on the processor 520 executing software instructions stored by a non-transitory computer-readable medium, such as the memory 530 and/or the storage component 540. A computer-readable medium is defined herein as a non-transitory memory device. A memory device includes memory space within a single physical storage device or memory space spread across multiple physical storage devices.

Software instructions may be read into the memory 530 and/or the storage component 540 from another computer-readable medium or from another device via the communication interface 570. When executed, software instructions stored in the memory 530 and/or storage component 540 may cause the processor 520 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method of visual presentation of device compliance data enabling intuitive identification of network requirement non-compliance and targeted response thereto, the method comprising:
receiving device data gathered from a plurality of devices communicably connected to a network, the device data representing values of features and resulting activity of the devices;
in a data analytics system executing on a processor, analyzing the device data to identify devices failing to comply with each network requirement of a predetermined set of network requirements, to thereby generate compliance analysis results;
selectively filtering the compliance analysis results according to at least one selected device feature of a plurality of predetermined device features, to thereby generate filtered analysis results representing a filtered subset of the plurality of devices;
in a graphic user interface application executing on a processor, generating at least one graphical chart indicating an extent of non-compliance, among the filtered subset of the plurality of devices, with a selected subset of the network requirements, according at least in part to the filtered analysis results; and
presenting the graphical chart in a graphic user interface rendered on a display.

2. The method of claim 1, further comprising executing a preset automated response based at least in part on identification of devices performing non-compliant activity within the network, to thereby reduce the non-compliant activity of the identified devices.

3. The method of claim 1, wherein the received device data is in the form of a periodic compilation of data.

4. The method of claim 1, wherein the received device data is in the form of a real-time data stream.

5. The method of claim 1, wherein the plurality of predetermined device features includes a region in which the device is located.

6. The method of claim 1, wherein the plurality of predetermined device features includes a domain to which the device is connected.

7. The method of claim 1, wherein the extent of non-compliance is presented in a plurality of graphical charts selectively arranged within the graphic user interface, each of the plurality of graphical charts rendered according to a chart style selected from a set of predesigned chart styles.

8. A system for visual presentation of device compliance data enabling intuitive identification of network requirement non-compliance and targeted response thereto, the system comprising:
a data analytics system executing on a processor and configured to analyze device data to identify devices failing to comply with each network requirement of a predetermined set of network requirements, to thereby generate compliance analysis results, the device data being gathered from a plurality of devices communicably connected to a network, the device data representing values of features and resulting activity of the devices;
a database implemented in a computer memory and configured to store the compliance analysis results; and
a graphic user interface application executing on a processor and configured to:
selectively filter the compliance analysis results according to at least one selected device feature of a plurality of predetermined device features, to thereby generate filtered analysis results representing a filtered subset of the plurality of devices,
generate at least one graphical chart indicating an extent of non-compliance, among the filtered subset of the plurality of devices, with a selected subset of the network requirements, according at least in part to the filtered analysis results, and
render a graphic user interface on a display, the graphical chart being presented in the graphic user interface.

9. The system of claim 8, wherein the data analytics system is further configured to execute a preset automated response based at least in part on identification of devices performing non-compliant activity within the network, to thereby reduce the non-compliant activity of the identified devices.

10. The system of claim 8, wherein the data analytics system receives the device data in the form of a periodic compilation of data.

11. The system of claim 8, wherein the data analytics system receives the device data in the form of a real-time data stream.

12. The system of claim 8, wherein the plurality of predetermined device features includes a region in which the device is located.

13. The system of claim 8, wherein the plurality of predetermined device features includes a domain to which the device is connected.

14. The system of claim 8, wherein the graphic user interface application is further configured to present the extent of non-compliance in a plurality of graphical charts selectively arranged within the graphic user interface, each of the plurality of graphical charts rendered according to a chart style selected from a set of predesigned chart styles.

15. A non-transitory computer-readable recording medium having recorded thereon instructions executable by at least one processor to perform a method of visual presentation of device compliance data from a network enabling intuitive identification of requirement non-compliance and targeted response thereto, the method comprising:
receiving device data gathered from a plurality of devices communicably connected to the network, the device data representing values of features and resulting activity of the devices;
in a data analytics system executing on a processor, analyzing the device data to identify devices failing to comply with each network requirement of a predetermined set of network requirements, to thereby generate compliance analysis results;
selectively filtering the compliance analysis results according to at least one selected device feature of a plurality of predetermined device features, to thereby generate filtered analysis results representing a filtered subset of the plurality of devices;
in a graphic user interface application executing on a processor, generating at least one graphical chart indicating an extent of non-compliance, among the filtered subset of the plurality of devices, with a selected subset of the network requirements, according at least in part to the filtered analysis results; and
presenting the graphical chart in a graphic user interface rendered on a display.
